(19) United States
(12) Patent Application Publication
(10) Pub. No.: US 2007/0147437 A1
(43) Pub. Date: Jun. 28, 2007

(54) Communication system and communication method

(76) Inventors: Yoshiki Yasui, Hamura-shi (JP); Daisuke Yashima, Koganei-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/643,905

(22) Filed: Dec. 22, 2006

(30) Foreign Application Priority Data
Dec. 26, 2005 (JP) 2005-373504

(51) Int. Cl. H04J 3/06

(52) U.S. Cl. 370/519; 370/508

(57) ABSTRACT

According to one embodiment, a communication system with a transmitting device and a receiving device communicably connected thereto, wherein the transmitting device comprises a packet transmitting unit to transmit a data packet to the receiving device and a retransmission buffer which stores the data packet for a retransmission and the receiving device comprises a validity determining unit which receives the data packet from the transmitting device to determine validity of the data packet and an acknowledgement transmitting unit which transmits a positive acknowledgement showing that the data packet is approved or a negative acknowledgement showing that the data packet is not approved at prescribed intervals on the basis of the determination result from the validity determining unit. The communication system further comprises an adjusting mechanism which adjusts a size of the retransmission buffer and a timing of the transmission of the acknowledgement to the data packet from the transmitting device.

### CROSS-REFERENCE TO RELATED APPLICATIONS

This application is based upon and claims the benefit of priority from Japanese Patent Application No. 2005-373504, filed Dec. 26, 2005, the entire contents of which are incorporated herein by reference.

### BACKGROUND

1. Field

One embodiment of the present embodiment relates to a communication system and a communication method.

2. Description of the Related Art

In communications of data packets among computers, to maintain data distributions with reliability, when correctly receiving data packets from a transmitting device, the receiving device returns an acknowledgement to a transmission side. In such a communication system, for instance, Jpn. Pat. Appln. KOKAI Publication No. 2001-111618 discloses a communication system for a packet communication between a transmission station and a reception station, wherein the transmission station comprises a means for recording transmission times of DT packets to measure reception times of acknowledgement (ACK) packets responding to the DT packets, a means for calculating round-trip response times by the differences between the reception times of the ACK packets and the transmission times of the corresponding DT packets, a means for measuring reception intervals of the ACK packets, and a means for calculating optimal window sizes on the basis of the round-trip response times and the reception intervals.

### BRIEF DESCRIPTION OF THE SEVERAL VIEWS OF THE DRAWINGS

A general architecture that implements the various features of the invention will now be described with reference to the drawings. The drawings and the associated description are provided to illustrate embodiments of the invention and not to limit the scope of the invention.

FIG. 1 is an exemplary view for explaining procedures of TLP approval by a retransmission buffer and an acknowledgement (Ack) data link layer packet (DLLP);

FIG. 2 is an exemplary view illustrating one example of contents of a retransmission buffer;

FIG. 3 is an exemplary view for explaining an outline of a first embodiment of the present invention;

FIG. 4 is an exemplary view illustrating an embodiment of Ack DLLP transmission delay control in a Vendor specific DLLP (VS DLLP);

FIG. 5A is an exemplary flowchart of processing on a TLP transmission side in the first embodiment;

FIG. 5B is another exemplary flowchart of the processing on the TLP transmission side in the first embodiment;

FIG. 6 is an exemplary flowchart of processing on a TLP reception side in the first embodiment;

FIG. 7 is an exemplary view for explaining an outline of a second embodiment of the present invention;

FIG. 8 is an exemplary flowchart illustrating operations of the second embodiment;

FIG. 9 is an exemplary view for explaining an outline of a third embodiment of the present invention;

FIG. 10A is an exemplary flowchart illustrating operations of the third embodiment;

FIG. 10B is another exemplary flowchart illustrating operations of the third embodiment;

FIG. 11 is an exemplary view for explaining an outline of mounting a retransmission buffer using a general ring buffer;

FIG. 12A is an exemplary control flowchart of a pointer base;

FIG. 12B is another exemplary control flowchart of a pointer base;

FIG. 13A is an exemplary view illustrating an aspect of reducing a writing limit value to displace turn-back positions of a buffer;

FIG. 13B is another exemplary view illustrating an aspect of reducing a writing limit value to displace turn-back positions of a buffer;

FIG. 14 is an exemplary view for explaining an outline of a fourth embodiment of the present invention;

FIG. 15 is an exemplary flowchart illustrating operations of a fourth embodiment;

FIG. 16 is an exemplary view for explaining an outline of a fifth embodiment of the present invention;

FIG. 17A is an exemplary flowchart illustrating operations of the fifth embodiment;

FIG. 17B is another exemplary flowchart illustrating operations of the fifth embodiment;

FIG. 18 is an exemplary view for explaining an outline of a sixth embodiment of the present invention; and

FIG. 19 is an exemplary view illustrating a mounding example of a VS DLLP using a method in the sixth embodiment.

### DETAILED DESCRIPTION

Various embodiments according to the invention will be described hereinafter with reference to the accompanying drawings. In general, according to one embodiment of the invention, a communication system with a transmitting device and a receiving device communicably connected thereto, wherein the transmitting device comprises: a packet transmitting unit to transmit a data packet to the receiving device; and a retransmission buffer which stores the data packet, to be transmitted from the transmitting device to the receiving device, for a retransmission, the receiving device comprises: a validity determining unit which receives the data packet from the transmitting device to determine validity of the data packet; and an acknowledgement transmitting unit which transmits a positive acknowledgement showing that the data packet is approved or a negative acknowledgement showing that the data packet is not approved to the transmitting device at prescribed intervals on the basis of the determination result from the validity determining unit; and the communication system further comprises an adjusting mechanism which adjusts one of a size of the retransmission buffer and a timing of the transmission of the acknowledgement to the data packet from the transmitting device. Some forms of the adjusting mechanism are described in the embodiments below.

Here, the case in which one embodiment of the invention is applied to a peripheral component interface (PCI) Express that is the next-generation PCI bus interface standards will be described. The PCI Express is a serial bus to be upward compatibility of a PCI bus, and has a wide data bandwidth of a maximum 2.5 Gbps per lane and of a maximum 32-lane.

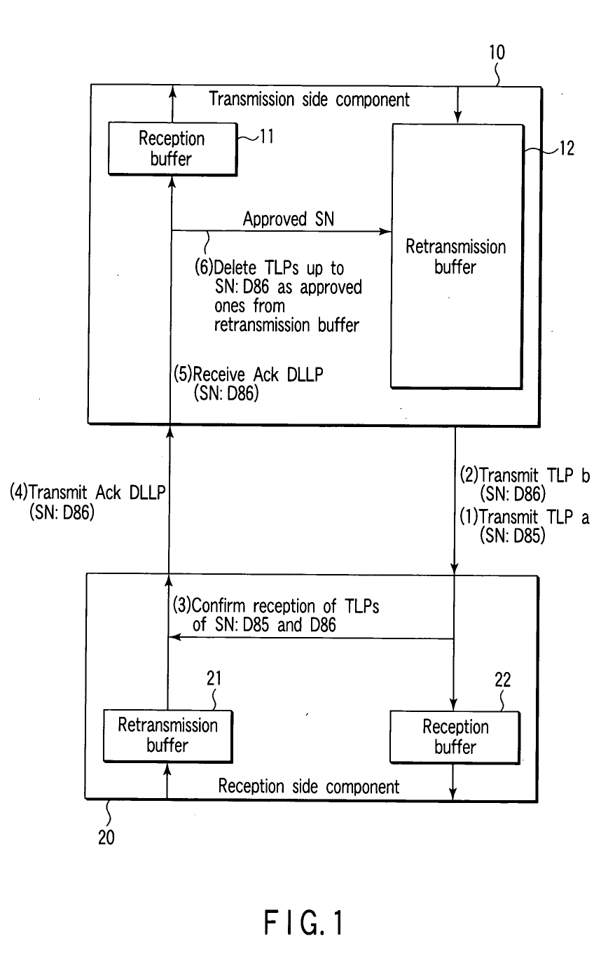

Hereinafter, a function which is provided for a data link layer defined with the PCI Express standards and which ensures validity of transaction layer packets (TLPs) transmitted and received among links by referring to FIG. 1.

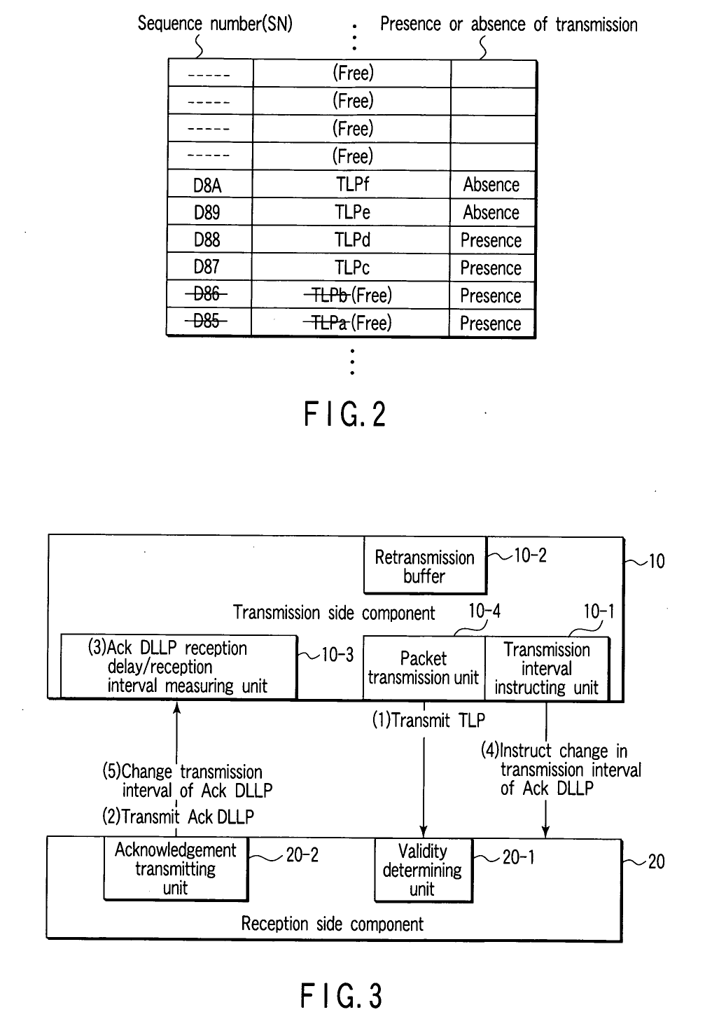

FIG. 1 is a view for explaining procedures of TLP approval through a retransmission buffer and the Ack DLLP, and a transmission side component 10 having a reception buffer 11 and a retransmission buffer 12, and a reception side component 20 having a reception buffer 22 and a retransmission buffer 21 are connected communicably. In FIG. 1, at first, the transmission side component 10 transmits a TLPa and a TLPb to the reception side component 20 (procedures S1 and S2). The TLPa and TLPb are, as shown in FIG. 2, recorded in the retransmission buffer 12 together with the below-mentioned sequence numbers (SNs) (wherein, they are D85 and D86). The reception side component 20 confirms the receptions of the TLPs of SNs of D85 and D86 (procedure S3). Here, it is presumed that after receiving the TLP of D85, the reception side component 20 receives the TLP of D86. The reception side component 20 then transmits the Ack DLLP of the SN of D86 to the transmission side component 10 (procedure S4). The transmission side component 10 received the Ack DLLP relating to the TLP of D86 then comes to know the approval of the TLP of D86 (procedure S5). Next, the transmission side component 10 deletes the TLPs up to the SN of D86 from the retransmission buffer 12, as the already approved ones (procedure S6).

The foregoing procedures will be described in detail hereinafter. To achieve a function of assuring the validities of the TLPs transmitted and received among links, sequence numbers and link cyclic redundancy check (LCRC) are used on the TLPs. The sequence numbers are IDs of 12 bit indicating proper values as sequence numbers for the TLPs of previous 4,096 pieces, and the IDs are generated when the transmission side component 10 transmits the TLPs. The reception side component 20 can determine the validities whether any drop out of receptions of the TLPs do not exist by using the continuity.

On the other hand, the LCRC is cyclic redundancy check (CRC) with 32 bit. The LCRC is generated when the transmission component 10 transmits the TLPs, and the reception side component 20 compares the LCRC to the CRC calculated by the reception side component 20 itself to enable detecting an error.

Like this, a data link layer of the reception side component 20 determines the validity of the TLP in accordance with whether the sequence number and the LCRC are correct or not. At this moment, when receiving a valid TLP, the reception side component 20 sends back an Ack DLLP (positive DLLP), and when receiving an invalid TLP, it sends back a Nak DLLP (negative DLLP).

The data link layer of the transmission side component 10 stores once the transmitted TLP in the retransmission buffer, if the approval has been notified through the Ack DLLP, the transmission side component 10 deletes the approved TLP from the retransmission buffer 12. When it is notified that at least one TLP has not been approved through the Nak DLLP, the transmission side component 10 retransmits all the TLPs later the not approved TLPs remaining in the retransmission buffer 12 to the reception side component 20. However, it is not always necessary for the Ack DLLP indicating the approval to be transmitted for every time when the reception side component 20 receives one TLP, transmitting the sequence number of the TLP approved last by loading it on the Ack DLLP allows simultaneous approval up to the TLPs indicated with the sequence number. This procedure restricts the number of pieces of the transmissions of the Ack DLLPs and has an effect on restriction of a reduction in the bandwidth due to the transmissions of the Ack DLLPs.

The transmission delay of the Ack DLLPs is not defined accurately as standards, only rough guide line is disclosed, and depends heavily on mounting.

Embodiments of the present invention will be set forth in detail hereinafter with reference to the drawings.

### First Embodiment

FIG. 3 is a view for explaining an outline of a first embodiment of the present invention. At first, a packet transmitting unit 10-1 of the transmission side component 10 transmits the TLP to the reception side component 20 (procedure ST1). When receiving the TLP, the reception side component 20 determines the validity of a packet by means of a validity determining unit 20-1, and if it is valid, an acknowledgement transmitting unit 20-2 transmits the Ack DLLP to the transmission side component 10 (procedure ST2). An Ack DLLP reception delay/reception interval measuring unit 10-3 of the transmission side component 10 measures delay or reception intervals from the transmission of the TLP to the reception of the Ack DLLP (procedure ST3).

A transmission interval instructing unit 10-4 of the transmission side component 10 transmits an instruction to change the transmission intervals of the Ack DLLPs to the reception side component 20 in response to the measurement results at that time (procedure ST4). When receiving the instructions, the reception side component 20 changes the transmission intervals of the Ack DLLPs (procedure ST5) then transmits the Ack DLLPs to the transmission side component 10.

Hereinafter, the foregoing procedures will be described in more detail. The size of the retransmission buffer, which is in the transmission side component as a device on the side of transmitting the TLP and is mounted as a component of the PCI Express, and an Ack transmission latency limit value to decide issue intervals of the Ack DLLPs mounted on the reception side component as an opponent device each have mutual optimum mounting or setting. If they are not optimum, for instance, in contrast to the size of the retransmission buffer, if the Ack transmission latency limit value is too large or too small, each bandwidth results in being limited. A document “PCI Express Base Specification 1.1” that is the standards of the OCI Express discloses a rough guide line of the Ack latency limit value, however; the size of the retransmission buffer and the Ack transmission latency limit value are values which cannot be decided optimally, without having to take the mounting or setting of the connected reception component into account.

Therefore, in the first embodiment, the transmission side component measures the time after the transmission side component transmits the TLP up to the time when the reception side component receives the Ack DLLP of its TLP. If the measured time is not appropriate, the problem is solved by transmitting the instruction to change the transmission delay of the Ack DLLP to the reception side component.

As for a means for transmitting the instruction, any specific restriction being not given, for example, a vendor defined message (VD Msg) or Vendor specific DLLP (VS DLLP) defined in the PCI Express standards and opened to a user (vendor) may be used. In these packets, areas allowed to be freely defined by the vendor being present, the information to change the transmission delay is transmitted by using the areas. The information to be transmitted may be the Ack DLLP transmission delay itself, and a control method for converging the Ack DLLP transmission delay to a value intended by the TLP transmission side by choosing the instructions to lengthen the current intervals of the Ack DLLPs and the instructions to shorten the current intervals thereof is possible approach.

In relation to the transmission delay, there are some possibilities that a range possible to be operated on the Ack DLLP issuing side and a limit of granularity have each limit, so that the instructions for changes in the Ack DLLP transmission delay from the TLP transmission side have the granularity of a certain extent. Therefore, it is preferable to be employed histolysis control with an object to keep the delay not to one point but within a fixed time period. Thereby, trying the adjustment of the Ack DLLP transmission delay on the TLP transmission side and resulting in the over issuing of the VD Mag or VS DLLP causes suppression of a reduction in bandwidth.

From the view point of suppressing the reduction in bandwidth, it is preferable to avoid continuous issuing of the VD Msg or VS DLLP for the purpose of controlling the Ack DLLP transmission delay, and to issue the VD Msg or VS DLLP for each TLP transmission of a fixed number, or for each fixed time period. Of course, there is no need to transmit the VD Msg or VS DLLP if the Ack DLLP transmission delay is optimum in the view from the TLP transmission side.

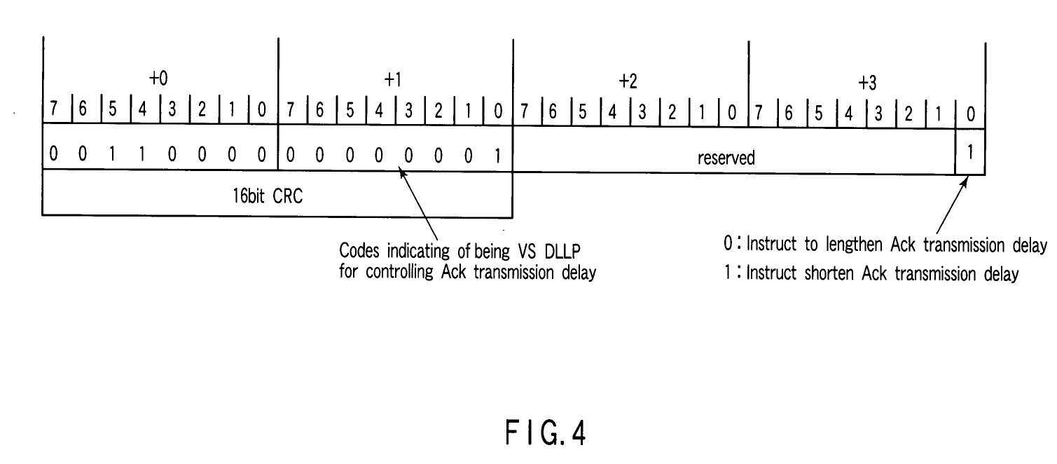

FIG. 4 is a view showing a mounting example of Ack DLLP transmission delay control on the VS DLLP. In the mounting example, Byte 1 being 01h indicates that the VS DLLP is the VS DLLP for the Ack DLLP transmission delay control; a bit 0 of Byte 3 being 0b indicates to lengthen the Ack DLLP transmission delay; and the bit 0 being 1b indicates to lengthen the Ack DLLP transmission delay. When the device which received the VS DLLP provides support, the later Ack DLLP transmission delay is changed in accordance with the value of the bit 0 of Byte 3 of the received VS DLLP.

A support situation of the VS DLLP sometimes can be determines from a vendor ID and device ID registered in a configuration register at an opponent device, however; a support situation of the opponent device cannot determine from the other device usually. Therefore, although the Ack DLLP transmission control regarding the present invention has been tried several times, when the Ack DLLP transmission delay is not improved, there is every possibility that the opponent device has not been supported yet. So that the stoppage of the function of the Ack DLLP transmission delay control, namely, the stoppage of the issue of the VS DLLP indicating the function is much better to cause suppressing the reduction in bandwidth.

As mentioned above, both the VD Msg and VS DLLP being available for the packet to be used for the control of the Ack DLLP transmission delay, since the control of retransmission buffer and Ack DLLP are the functions of the data link layer, it is preferable to use the DLLP that is the packet of the data link layer. Thereby, the VD Msg is effective to avoid consumption of the capacity of the retransmission buffer.

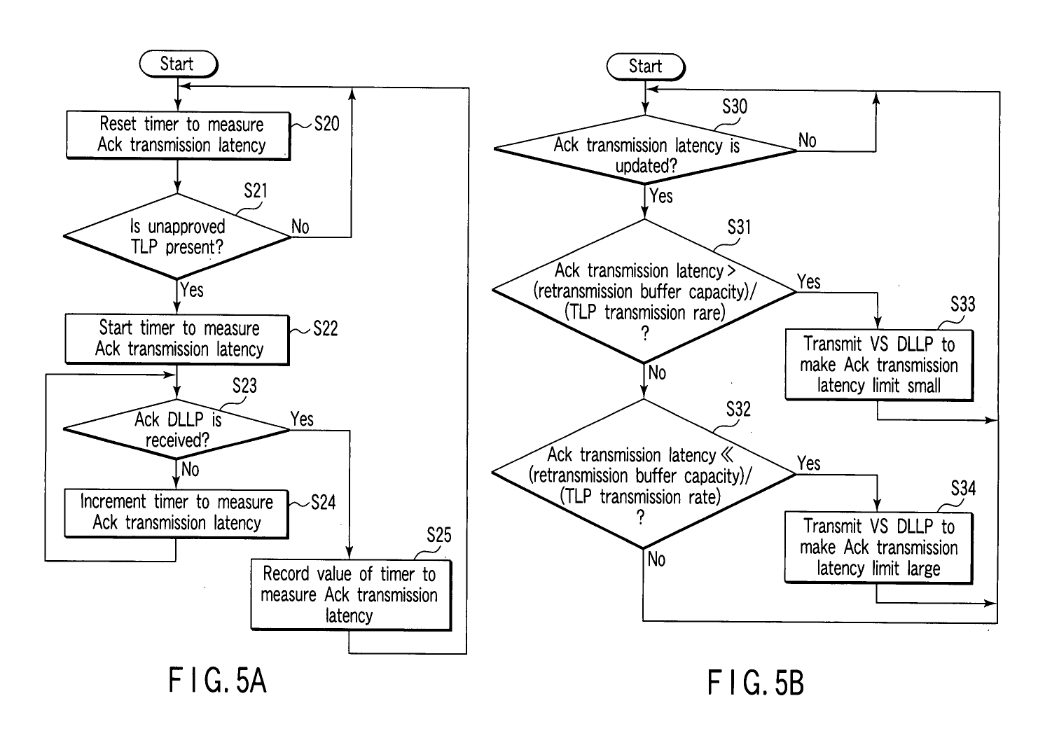

FIG. 5A and FIG. 5B each show flowcharts of processing on the TLP transmission sides regarding the first embodiment. Here, as one example, they each show the case in which a circuit similar to an Ack Nak latency timer control circuit on the TLP reception side is mounted. The TLP transmission side mounts a timer for Ack DLLP transmission latency measurement and operates the timer in the case of presence of an unapproved TLP (blocks S20-S22 in FIG. 5A) to measure the time until the TLP transmission side receives the Ack DLLP (blocks S23-S25).

That is, after resets the timer Ack transmission latency measurement (block S20), the TLP transmission side determines whether the unapproved TLP has been present or not (block S21). In the case of NO, the TLP transmission side returns to the block S20, when the TLP transmission side becomes YES, it starts the timer for the Ack transmission latency measurement (block S22). Next to this, it determines whether the TLP transmission side has received the Ack DLLP or not (block S23), in the case of “NO”, it increments the timer for the Ack transmission latency measurement by one (block S24), after this, it returns to the block S23. Here, in the case of “Yes”, it records the value of the timer for the Ack transmission latency measurement (block S25), then, it returns to the block S20.

Next, in blocks ST20-ST24 in FIG. 5B, the time measured in the forgoing way is set as the Ack DLLP transmission latency; it is determined whether or not the measured value is suitable for the TLP transmission circuit. If the link is normal, the case, in which the Ack DLLP transmission latency satisfies the following equation, seems to be most efficient.
Ack DLLP transmission latency=(capacity of retransmission buffer)/(TLP transmission rate)

It is preferable for the TLP transmission rate to be calculated with rate except overhead of a DLLP of an updated FC DLLP, etc., and an OS and a TLP of an SKP ordered set, etc.

If it is determined that the Ack transmission latency is updated (block S30), it is determined whether or not the Ack DLLP transmission latency is larger than (capacity of retransmission buffer)/(TLP transmission rate) (block S31). If the Ack DLLP transmission latency is smaller than the measured Ack transmission latency, there is every possibility that the retransmission buffer 12 becomes full due to the delay of the Ack DLLP, the TLP transmission side instructs the circuit on the TLP reception side to make the Ack transmission latency small by using the vendor specific (VS) DLLP (block S33). On the contrary, if the calculated Ack transmission latency is extremely larger than the measured Ack DLLP transmission latency (block S32), since there is a possibility that the use efficiency of the retransmission buffer is poor and that the use efficiency of the link due to the frequent Ack DLLP transmission is poor, the TLP transmission side instructs the circuit of the TLP reception side component to make the Ack DLLP transmission latency large by using the VS DLLP (block S34).

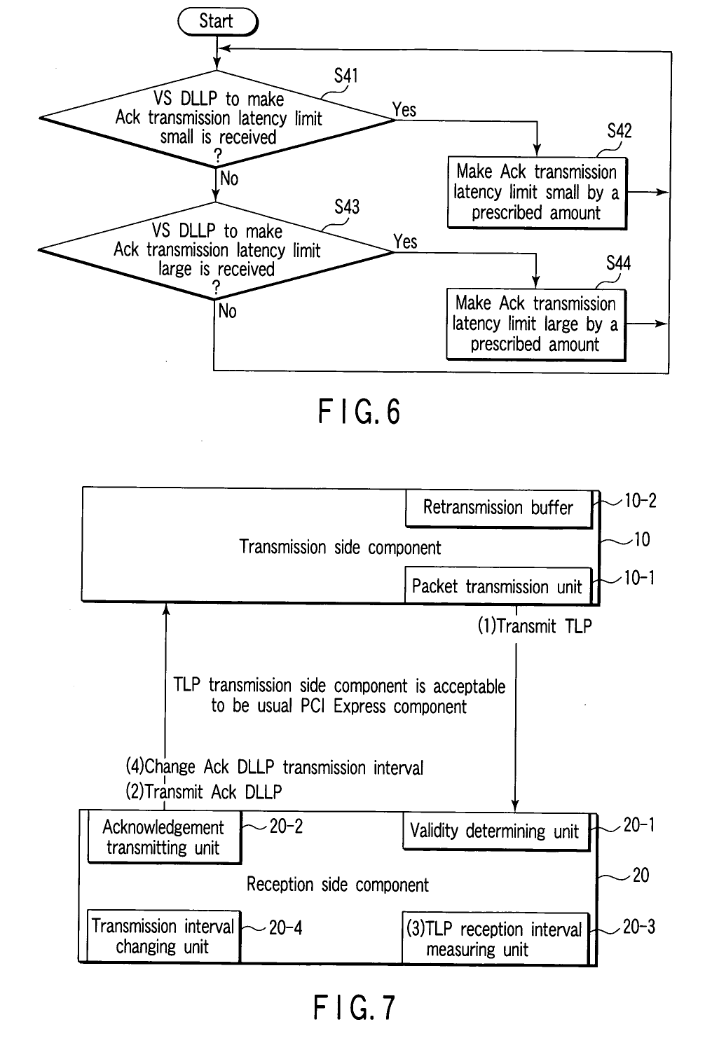

FIG. 6 shows a flowchart of processing on the TLP reception side in the first embodiment. In the reception side, based on the VS DLLP transmitted from the TLP transmission side, actual Ack DLLP transmission latency is changed. Namely, at first, the TLP reception side determines whether the VS DLLP making the Ack transmission latency limit smaller is received or not (block S41), If “Yes”, it makes the Ack transmission latency limit small by a prescribed amount (block S42), and if “No”, it determines whether the VS DLLP making the Ack transmission latency limit larger is received or not (block S43). If “No”, the TLP reception side returns to the block S41, and if “Yes”, it makes the Ack transmission latency limit large by a prescribed amount (block S44).

According to the first embodiment, a concrete method for optimizing the relation between the retransmission buffer size and the Ack transmission latency limit is presented. Thereby, it becomes possible to easily maximize the bandwidth, or to save a hardware resource by not having an unnecessary retransmission buffer.

### Second Embodiment

A second embodiment of the present invention will be described hereinafter. FIG. 7 is a view for explaining an outline of the second embodiment of the present invention. A packet transmitting unit 10-1 of the transmission side component transmits the TLP to the reception side component 20 (procedure SM1). When receiving the TLP, the reception side component 20 determines the validity of the packet by means of a validity determining unit 20-1, and if it has the validity, the reception side component 20 transmits the Ack DLLP from the acknowledgement 20-2 to the transmission side component 10 (procedure SM2). At this moment, a TLP reception interval measuring unit 20-3 of the reception side component 20 measures TLP reception intervals (procedure SM3). The acknowledgement transmitting unit 20-2 transmits the Ack DLLP the transmission intervals of which are varied in response to the measurement result of this moment to the transmission side component 10 (procedure SM4).

The foregoing procedures will be described in more detail hereinafter. Some causes result in stopping the flow of the TLPs, in decreasing the number of the flowing TLPs, or in lengthening the transmission intervals among devices connected through the PCI Express. One of them is the problem which comes from mismatch between the size of the retransmission buffer 12 of the transmission side component 10 and the transmission delay of the Ack DLLP of the reception side component 20. In contrast to the size of the retransmission buffer 12, if the transmission delay of the Ack DLLP is too large, the retransmission buffer 12 being filled with the unapproved TLPs, the next TLP cannot be possibly transmitted.

Therefore, the second embodiment is characterized in that if the reception interval of the TLPs is longer or if the number of the TLPs received in a fixed time period is smaller than a presumed or preset value, shortening the transmission delay of the Ack DLLP facilitates making of the free space in the retransmission buffer of the opponent device.

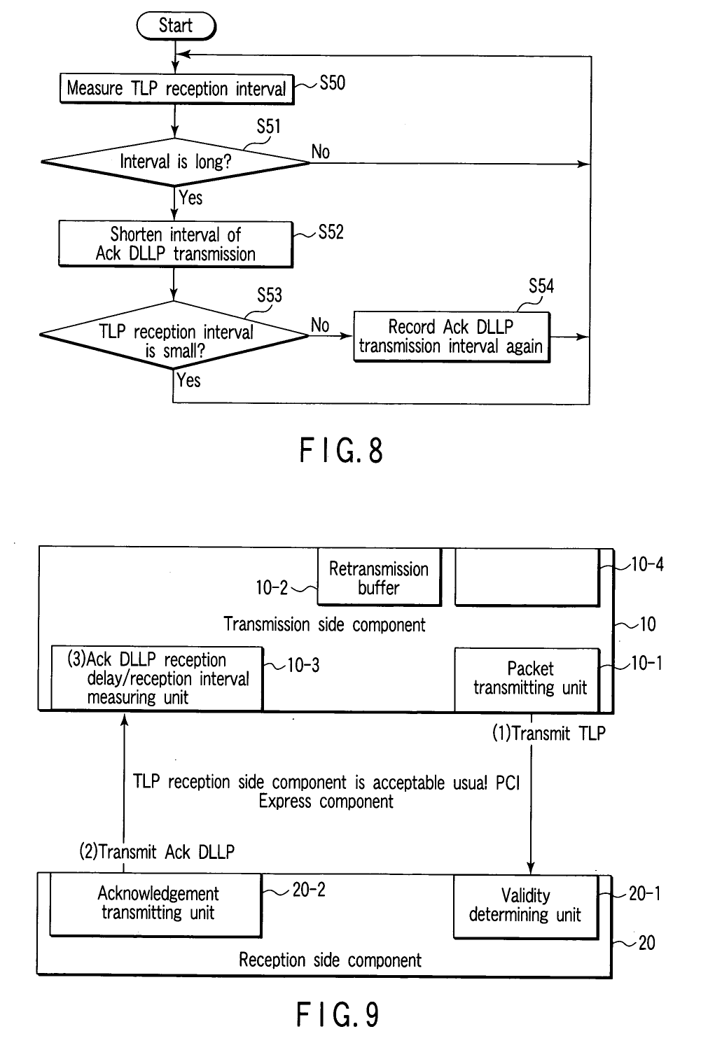

FIG. 8 is a flowchart depicting operations of the second embodiment. The TLP reception interval measuring unit 20-3 receives the TLPs from the transmission side component 10 to measure the TLP reception interval (block S50). Next, the measuring unit 20-3 determines whether the measured interval is longer or not on the basis of a threshold (block S51), if it determines “No”, it returns to the block S50, and if it determines “Yes”, namely, the interval is longer than the threshold, it shortens the Ack DLLP transmission interval (block S52). For the determination of the threshold, simple comparison may be useful, and it is also acceptable to only determine for the TLP receptions with fixed intervals such as burst transfer. If the TLP reception interval is shortened by shortening the DLLP transmission interval (block S53), it meaning that the retransmission buffer 10-2 of the transmission side component 10 becomes vacant frequently, such a state is maintained.

On the other hand, if the TLP reception interval has not changed, it is supposed that the TLP reception interval is long owing to the Ack DLLP, so that the transmission interval of the Ack DLLP is returned to former one (block S54). This is done so as not to waste a transmission bandwidth with an unnecessary Ack DLLP transmitted.

According to the second embodiment, it becomes possible to reduce the load of the retransmission buffer of the transmission side component.

### Third Embodiment

A third embodiment of the present invention will be set forth hereinafter. FIG. 9 is an illustration for explaining an outline of the third invention of the present invention. The packet transmitting unit 10-1 of the transmission side component firstly transmits the TLP to the reception side component 20 (procedure SH1). When the reception side component 20 receives the TLP, the validity determining unit 20-1 determines the validity of the packet, and if it is valid, the acknowledgement transmitting unit 20-2 transmits the Ack DLLP to the transmission side component 10 (procedure SH2). The Ack DLLP reception delay/reception interval measuring unit 10-3 measures the delay or the reception intervals up to the Ack DLLP reception (procedure SH3). Next, a retransmission buffer capacity changing unit 10-4 of the transmission side component 10 changes the capacity of the retransmission buffer in response to the measurement result at this moment (procedure SH4).

The foregoing procedures will be explained in detail hereinafter. As for a mounting method of the retransmission buffer, a method other than one having fixed hardware exclusive for the retransmission buffer, a method for sharing a buffer area with other function is a possible approach. In such a mounting method, suppressing the size of the buffer area assigned to the retransmission buffer minimally enables other function to utilize the remaining area at a maximum. However, as mentioned above, because the transmission delay of the Ack DLLP of the opponent device is not clear, in general, the transmission buffer is usually designed to have a sufficient margin.

Therefore, in the third embodiment, after transmitting the TLP, the transmission side component 10 measures the interval until the Ack DLLP is received, and dynamically adjusts the size of the retransmission buffer on the basis of the measured interval, then, releases the buffer area which has been occupied by the retransmission buffer to utilize it for other object. More specifically, the size of the retransmission buffer may be decided so as to roughly satisfy the following equation.
Required retransmission buffer size=(Ack DLLP transmission latency)×(TLP transmission rate)

Here, it is preferable for the TLP transmission rate to be calculated by the rate except the overhead of the DLLP of the updated FC DLLP, etc., and of the OS and TLP of the SKP ordered set, etc.

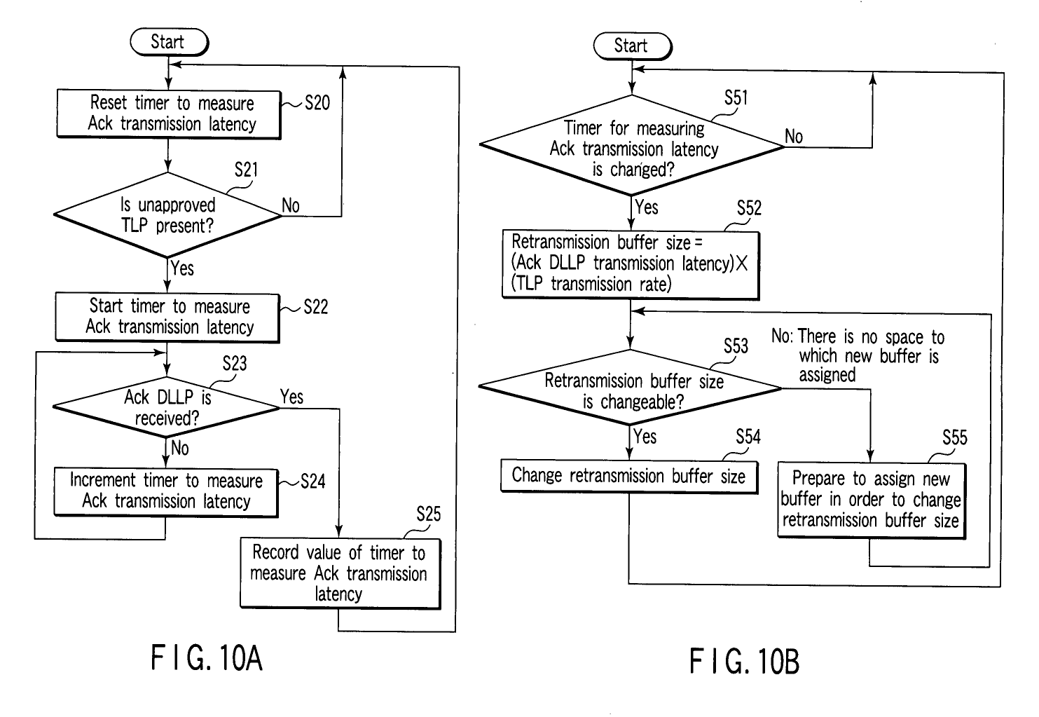

FIGS. 10A and 10B are flowcharts each depict operations of the third embodiment. Blocks of FIG. 10A being the same as those of FIG. 5A, their explanations will be eliminated. After a block S25, the flowchart of FIG. 10A shifts to a block S51 of FIG. 10B and determines whether any fluctuation exists in the Ack transmission latency or not. If the fluctuation exists in the Ack transmission latency, the third embodiment calculates an optimum buffer size on the basis of the aforementioned equation depending on the fluctuated value (block S52) to adjust the retransmission buffer. That is, the third embodiment determines whether the size of the retransmission buffer is changeable or not (block S53), if the determination shows “No”, the third embodiment determines that there is no space to which a new buffer is assigned and prepares assigning the new buffer to change the size of the retransmission buffer (block S55). On the contrary, if the determination in the block S53 shows “Yes”, the third embodiment changes the size of the retransmission buffer (block S54).

Here, the case of reduction (release) of the retransmission buffer does not cause any special problem, however; in the case of additional acquiring of the retransmission buffer, it becomes impossible to acquire the retransmission buffer sometimes. In such a case, the third embodiment waits until the additional acquiring of the retransmission buffer is completed or maintains the current capacity thereof.

As for other mounting method, continuous monitoring the interval between a writing pointer of the retransmission buffer (current TLP writing position on retransmission buffer) and a writing limit (TLP writing limit position on retransmission buffer), and dynamically adjusting the reference when the interval therebetween gets shorter mostly in a fixed time period, namely, when the retransmission buffer is occupied mostly, is a possible approach.

The writing limit being updated by receiving the Ack DLLP, dynamically controlling the size of the retransmission buffer in accordance with the interval between the writing pointer and the writing limit is equivalent to the controlling on the basis of the transmission frequency of the TLP and the Ack DLLP transmission delay.

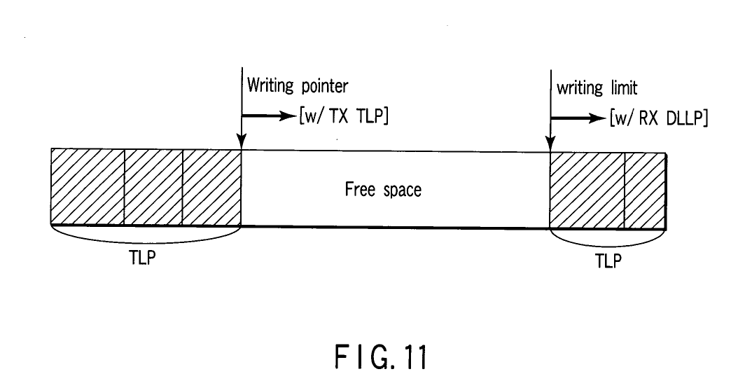

FIG. 11 is an illustration for explaining an outline of mounting the retransmission buffer using a general ring buffer. The retransmission buffer stores an unapproved TLP, and when the TLP transmitted from a transmitting circuit in a transaction layer is stored in the retransmission buffer, the retransmission buffer increments the writing pointer. On the other hand, when receiving the Ack DLLP from a facing component, the retransmission buffer approves the TLP, then, the increment of the writing limit by the retransmission buffer releases itself. Here, a part from the writing limit up to the writing pointer becomes a free space of the retransmission buffer.

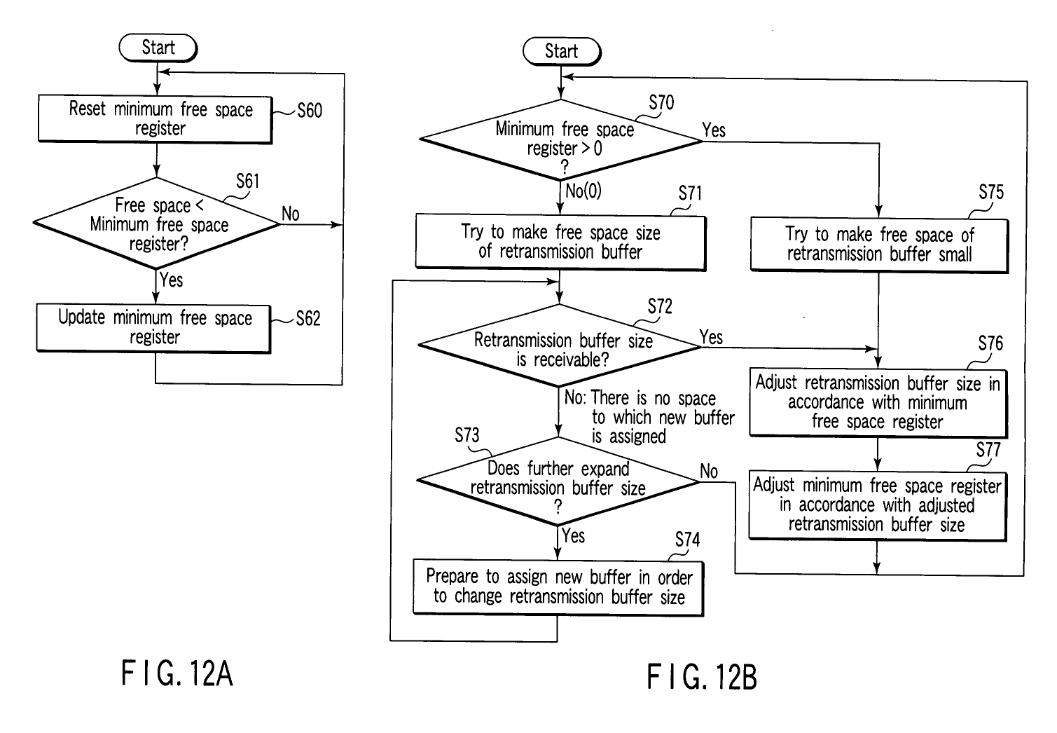

FIGS. 12A and 12B each illustrate control flowcharts of pointer bases. The free space in the retransmission buffer is governed by the writing limit and the writing pointer, and the free space is always calculated. When the calculated value becomes lower than a previous minimum value (minimum free space register), the minimum free space register is updated (blocks S60-S62 in FIG. 12A).

Next, the flowchart sifts to the flow in FIG. 12B to determine whether or not the minimum free space register is larger than 0 (block S70).

If the value of the minimum free space register is 0, it shows that the retransmission buffer became full in past, so that the flow tries to increase in capacity of the retransmission buffer (block S71) to determine whether the retransmission buffer size is available for receiving the TLP (block S72). In the case of “Yes”, the flow advances to the below-mentioned block S76, and in the case of “No”, the pointer-based control determines that any space to which a new buffer is assigned does not exist, and determines whether the size of the retransmission buffer should be further expanded or not (block S73). Here, in the case of “Yes”, the pointer-based control prepares to assign the new buffer for changing the size of the retransmission buffer (block S74) to return to the block S72.

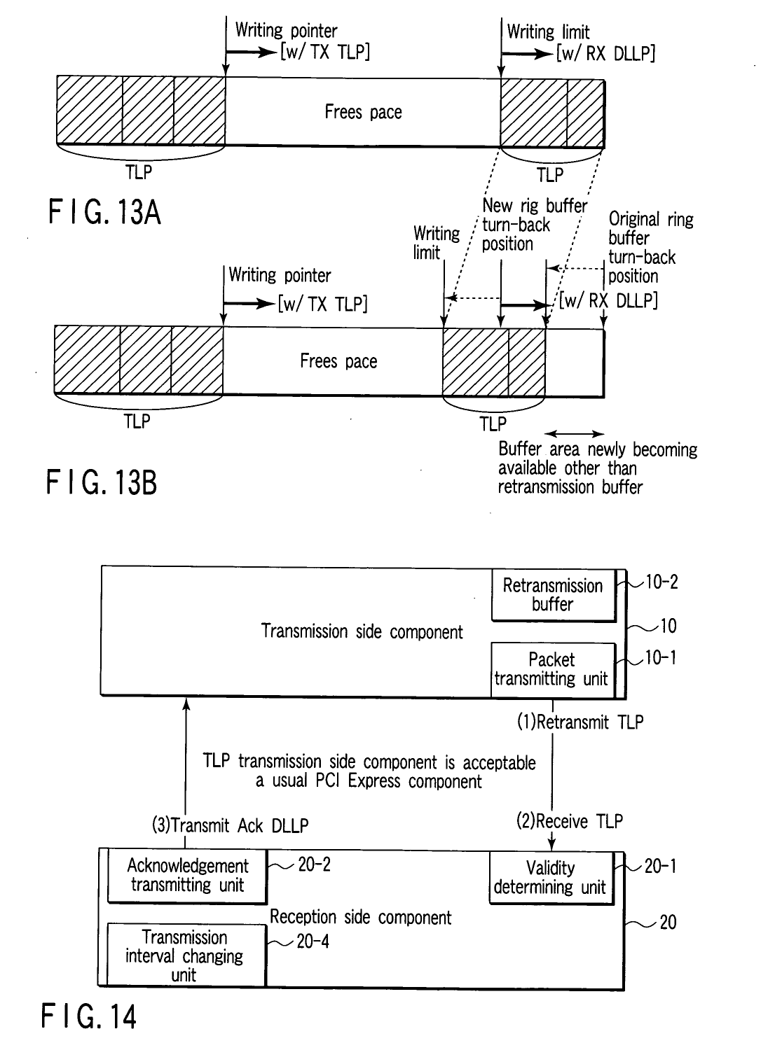

On the contrary, In the case of “Yes” in the determination of the block S70, namely, if the value of the minimum free space register is positive, or if it is equal to or more than a threshold not less than a fixed value, the fact shows that a waste retransmission buffer possibly exists. So that, for instance, as shown in FIGS. 13A and 13B, the reduction in the writing limit value and displacement of the turn-back position of the buffer causes reducing the size of the free space of the retransmission buffer (block S75).

Next to this, the point-base control adjusts the size of the retransmission buffer size in accordance with the minimum free space register (block S76), and in succession, it adjusts the minimum free space register depending on the adjusted retransmission buffer size (block S77).

Like this, the change in capacity of the retransmission buffer achieves efficient use of the retransmission buffer and makes it possible to assign the memory of the useless retransmission buffer to other use.

In the case of reduction in the size of the retransmission buffer, the useless area thereof may be assigned to other shared buffer. For example, a reception buffer (data link layer, or transaction layer) or a transmission buffer of a transaction layer is considerable for one example.

According to the third embodiment, the size of the retransmission buffer having been adjusted on the basis of the Ack DLLP transmission delay, the size thereof always can be adjusted in an optimum size.

### Fourth Embodiment

Hereinafter, an explanation will be given to a fourth embodiment of the present invention. FIG. 14 is a view for explaining an outline of the fourth embodiment of the present invention. Here, it is presumed that although the transmission side component 10 transmits the TLP to the reception side component 20, reception side component 20 cannot receive the Ack DLLP. In such a case, the transmission side component 10 retransmits the TLP in the retransmission buffer 10-2 to the reception side component 20 (procedure SS1). When the reception side component 20 receives the retransmitted TLP (procedure SS2), the validity determining unit 20-1 determines the validity, and if it is valid, the acknowledgement transmitting unit 20-2 transmits the Ack DLLP to the transmission side component 10 (procedure SS3). At this time, the transmission interval changing unit 20-4 makes the transmission interval of the Ack DLLP short then transmits it to the transmission side component 10 (procedure SS3).

The foregoing procedures will be described in detail hereinafter. In the PCI Express, when the transmission side component 10 cannot receive the Ack DLLP for a time period longer than a fixed time period after the transmission of the TLP therefrom, the transmission side component 10 retransmits the TLP which has not been approved yet into the retransmission buffer. Such situation also generating in the case in which a condition of a lane is poor due to an influence caused by a noise, etc., and in which the opponent device (reception side component 20) cannot accurately receive the packet, if the opponent device has received the TLP in an incomplete state, the opponent device returns the Nak DLLP telling the non-approval of the TLP, so that the fact causes the generation of the retransmission.

Therefore, in the fourth embodiment, when the reception side component 20 does not transmit both Ack DLLP and Nak DLLP, in receiving the TLPs with the sequence numbers previously received by the reception side component 20, that is, in the case in which the retransmission of the TLP from the transmission side component 10 is considered, the reception side component 20 suppresses the generation of the retransmission by reducing the transmission delay of the Ack DLLP after that time.

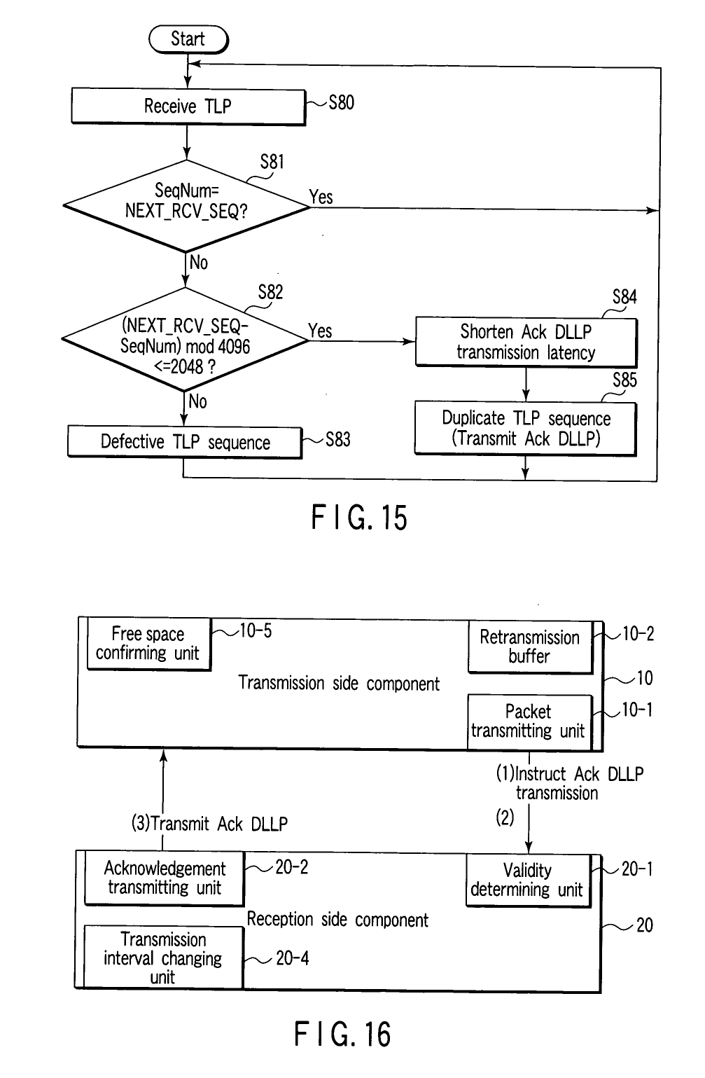

FIG. 15 is a flowchart showing operations in the fourth embodiment. The reception side component 20 firstly receives the TLP (block S80); next, the reception side component 20 determines whether or not the TLP is one with the sequence number (duplicated TLP) which is previously received by itself (blocks S81 and S82). In the case of “Yes”, the reception side component 20 shortens the Ack DLLP transmission latency (block S84), then, it sifts to duplicate TLP receiving sequence (transmission of Ack DLLP) (block S85). If the determination in the block S82 is “No”, the flowchart makes a shift to a defective TLP sequence (block S83).

According to the fourth embodiment, when it is supposed that the transmission side component 10 has been retransmitting the TLP, the reception side component 20 having made the transmission delay of the Ack DLLP after this time small, the generation of the retransmission can be suppressed.

### Fifth Embodiment

A fifth embodiment of the present invention will be set forth hereinafter. FIG. 16 is an illustration for explaining an outline of the fifth embodiment of the present invention. Here, in the transmission side component 10, a free space capacity confirming unit 10-5 detects the free space in the retransmission buffer 10-2 to transmit an instruction to change the transmission interval of the Ack DLLP from the packet transmitting unit 10-1 to the reception side component 20 in response to the detection result (procedure SM1). When the reception side component 20 receives the instruction (procedure SM2), the validity determining unit 20-1 determines the validity of the instruction, if it is valid, the transmission interval changing unit 20-4 changes the transmission interval of the Ack DLLP in accordance with the instruction. After this, the acknowledgement transmitting unit 20-2 transmits the Ack DLLP to the transmission side component 10 (procedure SM3).

The aforementioned procedures will be described in detail hereinafter. In the PCI Express standards, although it is defined that the transmission delay of the Ack DLLP should be transmitted within a defined and fixed time period; there is no specific definition about a transmission minimum interval. The first embodiment having instructed the adjustment of the Ack DLLP transmission interval (time) from the transmission side component to the reception side component 20, if an operation of the system is too late and it results in running short of the free space of the retransmission buffer on the transmission side, the transmission of the TLP results in stopping.

Therefore, in the fifth embodiment, an immediate notification of a transmission request for the Ack DLLP to the reception side component 20 accelerates timing of the transmission of the Ack DLLP from the reception side component 20, and makes it possible to restart the TLP transmission. The transmission side component 10 having comprehended the free space of the retransmission buffer 10-2, it is also possible to require the Ack DLLP transmission to the reception side component 20 later several packets in response to the free space of the retransmission buffer 10-2 for each time.

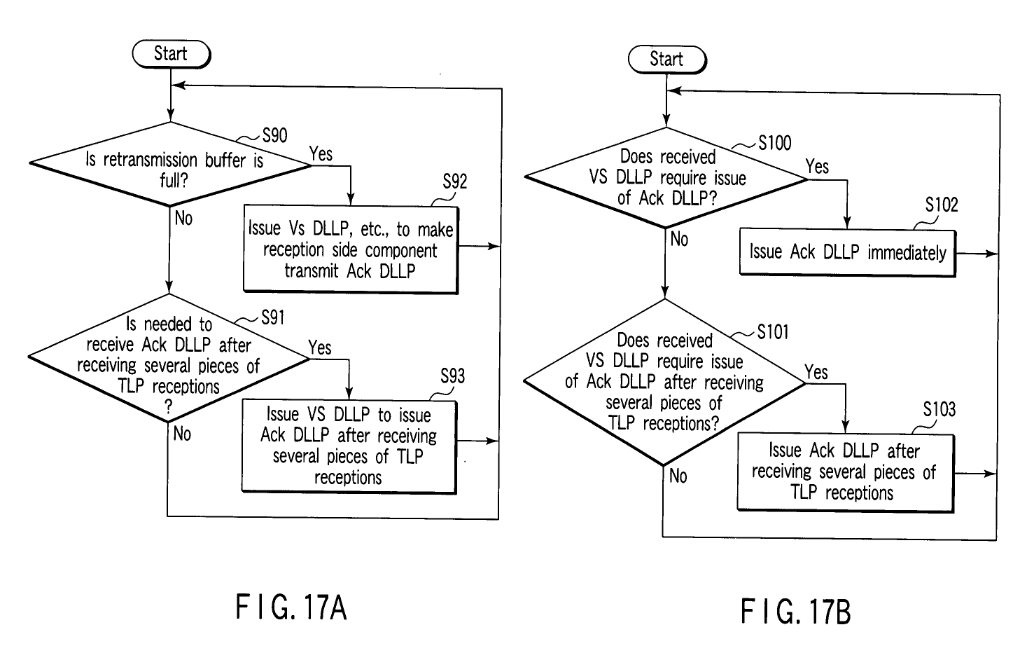

FIGS. 17A and 17B are flowcharts depicting operations of the fifth embodiment, which show the procedures of Ack DLLP transmission control (in immediate/defined TLP reception), and FIG. 17A shows a flow of the transmission side component 10, and FIG. 17B is a flow of the reception side component 20. The transmission side component 10 firstly determines whether the retransmission buffer is full or not (block S90). In the case of “Yes”, the transmission side component 10 issues the VS DLLP, etc., so as to make the reception side component 20 transmit the Ack DLLP (block S92). If the determination is “No” in the block S90, after receiving several pieces of the TLPs, the transmission side component 10 determines whether it should transmit the Ack DLLP or not (block S91). If the determination is “Yes”, the transmission side component 10 issues the VS DLLP so as to issue the Ack DLLP after receiving several pieces of TLPs (block S93). If the determination of the block S91 is “No”, the flow returns to the block S90.

Next, in a flow of the reception side component 20, at first, it determines whether or not the received VS DLLP requires the issue of the Ack DLLP (block S100). Here, in the case of “Yes”, the reception side component 20 immediately issues the Ack DLLP (block S102). In the case of “No”, the reception side component 20 determines whether or not the received VS DLLP requires the issue of the Ack DLLP after the receiving of the several pieces of TLPs (block S101). Here, if the determination is “Yes”, the reception side component 20 issues the Ack DLLP after receiving several pieces of TLPs (block S103). If the determination is “No”, the flow returns to the block S100.

### Sixth Embodiment

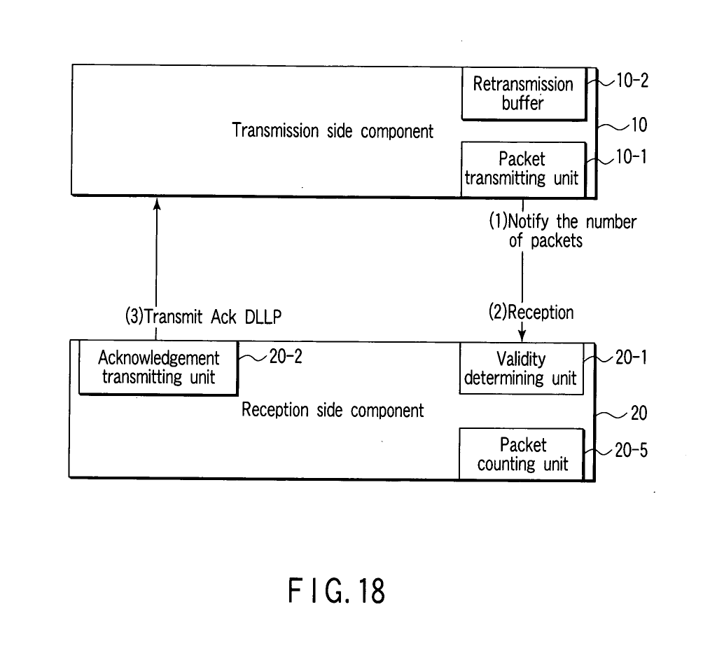

Hereinafter, a sixth embodiment of the present invention will be given an explanation. FIG. 18 is an illustration for explaining an outline of the sixth embodiment. In the first embodiment, having described the method by which the transmission side component controls the transmission delay of the Ack DLLP of the reception side component on the basis of time, another control method, which control on the basis of the number of packets, is a possible approach. The transmission side component notifies in advance if the Ack DLLP is desired by how many packet periods by using, for instance, VD Msg and VS DLLP to the reception side component 20 through the packet transmitting unit 10-1 (procedure SW1). In the reception side component 20, the validity determining unit 20-1 determines the validity of the received packets (procedure SW2), if the packets are valid, the packet calculating unit 20-5 counts the number of the received packets. At a stage in which the specified number of the packets has been received, the acknowledgement transmitting unit 20-2 transmits the Ack DLLP to the transmission side component 10 (procedure SW3).

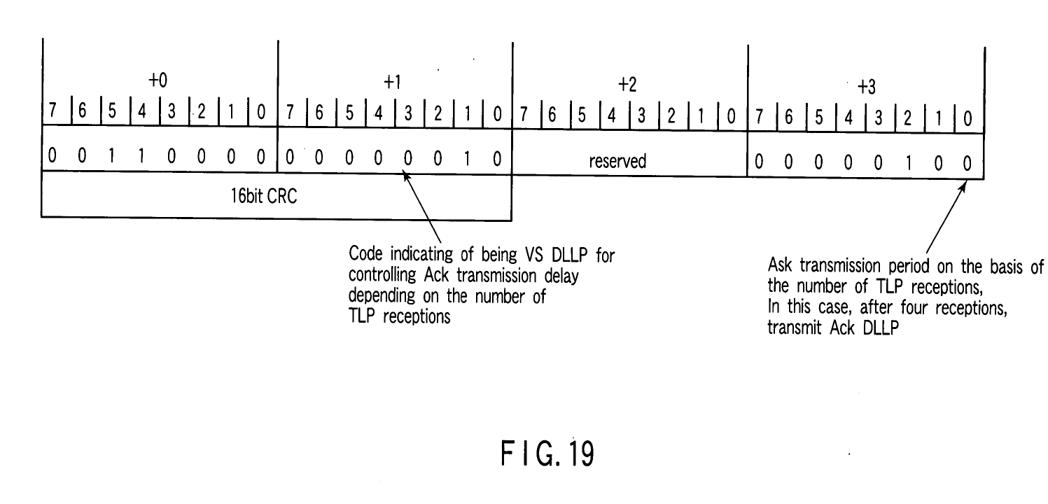

FIG. 19 shows a mounting example of the VS DLLP in the use of the method of the sixth embodiment.

The control methods of the transmission delay of the Ack DLLP described in the foregoing embodiments are not always necessary to be used individually; a plurality of the control methods may be employed and used in a combination thereof.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A communication system with a transmitting device and a receiving device communicably connected thereto, wherein
the transmitting device comprises:
a packet transmitting unit to transmit a data packet to the receiving device; and
a retransmission buffer which stores the data packet, to be transmitted from the transmitting device to the receiving device, for a retransmission,
the receiving device comprises:
a validity determining unit which receives the data packet from the transmitting device to determine validity of the data packet; and
an acknowledgement transmitting unit which transmits a positive acknowledgement showing that the data packet is approved or a negative acknowledgement showing that the data packet is not approved to the transmitting device at prescribed intervals on the basis of the determination result from the validity determining unit; and
the communication system further comprising an adjusting mechanism which adjusts one of a size of the retransmission buffer and a timing of the transmission of the acknowledgement to the data packet from the transmitting device.

2. The communication system according to claim 1, wherein
the transmitting device comprises as the adjusting mechanism:
a delay time measuring unit which measures a delay time from the transmitting of the data packet from the transmitting unit until the receiving of the positive acknowledgement from the receiving device; and
a transmission interval instructing unit which determines suitability of a transmission interval of the positive acknowledgement from the acknowledgement transmitting unit on the basis of the delay time measured by the delay time measuring unit and capacity of the retransmission buffer and transmits an instruction to change the transmission interval of the positive acknowledgement to the receiving device on the basis of the determination result.

3. The communication system according to claim 2, wherein
the transmission interval instructing unit compares the delay time measured by the delay time measuring unit to a value attained by dividing a capacity of the retransmission buffer with a transmission rate of the data packet and transmits an instruction to change the transmission interval of the positive acknowledgement to the receiving device on the basis of the comparison result.

4. The communication system according to claim 1, wherein
the receiving device comprises as the adjusting mechanism:
a reception interval measuring unit which measures a reception interval to receive the data packet from the transmitting device; and
transmission interval changing unit which determines suitability of a transmission interval of the positive acknowledgement transmitted from the acknowledgement transmitting unit on the basis of the reception interval measured by the reception interval measuring unit and changes the transmission interval of the positive acknowledgement in response to the determination result.

5. The communication system according to claim 1, wherein
the transmitting device comprises as the adjusting mechanism:
a delay time measuring unit which measures a delay time from the transmitting of the data packet from the transmitting unit until the receiving of the positive acknowledgement from the receiving device; and
a buffer capacity changing unit which changes a capacity of the retransmission buffer on the basis of the delay time measured by the delay time measuring unit.

6. The communication system according to claim 1, wherein
the receiving device comprises as the adjusting mechanism:
a transmission interval changing unit which determines whether or not the data packet retransmitted from the transmitting device is received when both the positive acknowledgement and the negative acknowledgement are not transmitted from the acknowledgement transmitting unit and changes a transmission interval of the positive acknowledgement on the basis of the determination result.

7. The communication system according to claim 1, wherein
the transmitting device comprises as the adjusting mechanism:
a free space confirming unit which confirms a free space of the retransmission buffer; and
a positive acknowledgement transmission instructing unit which outputs an instruction in order to make the receiving device transmit the positive acknowledgement to the transmitting device in accordance with the free space confirmed by the free space capacity confirming unit.

8. The communication system according to claim 1, wherein
the receiving device comprises as the adjusting mechanism a packet counting unit which counts the data packet from the transmitting device to determine whether or not a prescribed number of the data packet set by the transmitting device is transmitted, and
the acknowledgement transmitting unit transmits the acknowledgement to the transmitting device on the basis of the determination result from the packet counting unit.

9. A communication method for communicating between a transmitting device and a receiving device, wherein
transmitting at the transmitting device comprises:
transmitting a data packet to the receiving device; and
storing the data packet, transmitted from the transmitting device to the receiving device in a retransmission buffer, for a retransmission,
receiving at the receiving device comprises:
receiving the data packet from the transmitting device to determine validity of the data packet; and
performing an acknowledgement which transmits a positive acknowledgement showing that the data packet is approved or a negative acknowledgement showing that the data packet is not approved to the transmitting device at prescribed intervals on the basis of the determination result in the determining of the validity, and
the communicating further comprising adjusting which adjusts one of a size of the retransmission buffer and a timing of the transmission of the acknowledgement to the data packet from the transmitting device.

10. The communication method according to claim 9, wherein
the transmitting at the transmitting device comprises as the adjusting mechanism:
a delay time measuring which measures a delay time from the transmitting of the data packet from the transmitting until the receiving of the positive acknowledgement from the receiving device; and
a transmission interval instructing which determines suitability of a transmission interval of the positive acknowledgement from the acknowledgement transmitting on the basis of the delay time measured by the delay time measuring and capacity of the retransmission buffer and transmits an instruction to change the transmission interval of the positive acknowledgement to the receiving device on the basis of the determination result.

11. The communication method according to claim 10, wherein
the transmitting of the instruction compares the delay time measured in the measuring of the delay time to a value attained by dividing the capacity of the retransmission buffer with a transmission rate of the data packet and transmits an instruction to change the transmission interval of the positive acknowledgement to the receiving device on the basis of the comparison result.

12. The communication method according to claim 9, wherein
the receiving at the receiving device comprises as the adjusting mechanism:
measuring a reception interval which receives the data packet from the transmitting device; and
determining suitability of a transmission interval of the positive acknowledgement transmitted in the acknowledging on the basis of the reception interval measured in the measuring to change the transmission interval of the positive acknowledgement in response to the determination result.

13. The communication method according to claim 9, wherein
the transmitting at the transmitting device comprises as the adjusting mechanism:
measuring a delay time from the transmitting of the data packet from the transmitting until the receiving of the positive acknowledgement from the receiving device; and
changing a capacity of the retransmission buffer on the basis of the delay time measured in the measuring of the delay time.

14. The communication method according to claim 9, wherein
the receiving at the receiving device comprises as the adjusting mechanism:
determining whether or not the data packet retransmitted from the transmitting device are received when both the positive acknowledgement and the negative acknowledgement are not transmitted in the acknowledging to change a transmission interval of the positive acknowledgement on the basis of the determination result.

15. The communication method according to claim 9, wherein
the transmitting at the transmitting device comprises as the adjusting mechanism:
confirming a free space of the retransmission buffer; and
outputting an instruction to make the receiving device in order to transmit the acknowledgement to the transmitting device in accordance with the free space confirmed in the confirming of the free space.

16. The communication method according to claim 9, wherein
the receiving at the receiving device comprises as the adjusting mechanism:
counting the data packet from the transmitting device to determine whether or not a prescribed number of the data packet is transmitted from the transmitting device; and
transmitting the acknowledgement to the transmitting device on the basis of the determination result in the counting of the data packet.

17. A communication system with a transmitting device and a receiving device communicably connected thereto, wherein
the transmitting device comprises:
a packet transmitting means for transmitting a data packet to the receiving device; and
a retransmission buffer for storing the data packet, to be transmitted from the transmitting device to the receiving device, for a retransmission,
the receiving device comprises:
a validity determining means for receiving the data packet from the transmitting device to determine validity of the data packet; and
an acknowledgement transmitting means for transmitting a positive acknowledgement showing that the data packet is approved or a negative acknowledgement showing that the data packet is not approved to the transmitting device at prescribed intervals on the basis of the determination result from the validity determining means; and
the communication system further comprising an adjusting means for adjusting one of a size of the retransmission buffer and a timing of the transmission of the acknowledgement to the data packet from the transmitting device.
